(19) United States
(12) Patent Application Publication
(10) Pub. No.: US 2017/0065385 A1
(43) Pub. Date: Mar. 9, 2017

(54) DENTAL FLOSS HOLDING AND FEEDING DEVICE

(71) Applicant: Csaba Hollo, Budapest (HU)

(72) Inventor: Csaba Hollo, Budapest (HU)

(21) Appl. No.: 15/121,921

(22) PCT Filed: Feb. 25, 2015
(86) PCT No.: PCT/HU2015/000021

§ 371 Date: Aug. 26, 2016

(30) Foreign Application Priority Data
Feb. 26, 2014 (HU) P1400108

(51) Int. Cl. A61C 15/04

(52) U.S. Cl. CPC A61C 15/043

(57) ABSTRACT

Dental floss holding and feeding device that has a winding (2) made of dental floss filament (13) that comprises a central opening; a shaft (15) with an axis normal to the plane of the winding (2) and fitted in the opening; a base plate (11) supporting a side of the winding (2) and a closed space in the body (10) for locating the winding (2), furthermore a lead out opening (3) for an end portion of the winding (2); and a cutter (8) arranged across the path of the lead out filament (4) to cut the filament when being suddenly pulled, wherein the winding (2) has a flat, narrow shape compared to the size of its own diameter, the body (10) has a larger plane constituted by the base plate (11); the body (10) has a narrow rear edge (14) to which a cover (20) is attached that can be folded in a position parallel to the base plate (11) and opened by unfolding; an envelope (13) is attached to the base plate (11) that defines the closed inner space, the envelope (13) has an upper surface that is substantially parallel to the base plate (11), the height of the envelope (13) is substantially equal to the width of the rear edge (14), and the cover (20) in folded position covers the upper surface of the envelope (13), and behind the front edge of the base plate (11) a manipulation field (5) is provided that extends between the lead out opening (3) and the cutter (8), the manipulation field (5) enables holding the previously cut end of the filament (4) by hand, and it is defined by the shape of the envelope (13), and the cutter (8) is fixed to the base plate (11).

The invention relates to a dental floss holding and feeding device that comprises a body; a winding made of dental floss filament, the winding has a winding plane and defines a central opening normal to the plane of the winding; the device further comprises a shaft with an axis normal to the plane of the winding, the shaft is fitted in the opening of the winding that allows turning of the winding around the shaft; a base plate supporting a side of the winding and at least one closed space in the body for locating the winding; an opening defined in the wall of the closed space for leading out a filament that forms an end portion of the winding; and a cutter arranged across the path of the lead out filament to cut the filament when being suddenly pulled.

Several types of dental floss holding and feeding devices are known that have the afore described properties. An example of such designs can be found on the website www.oral-B.com in which the products sold under the commercial name Glide are introduced. The term “dental floss” has become a term explained e.g. in WIKIPEDIA where a further example is shown that has a box-like design. For providing a closer reference to the prio art devices a

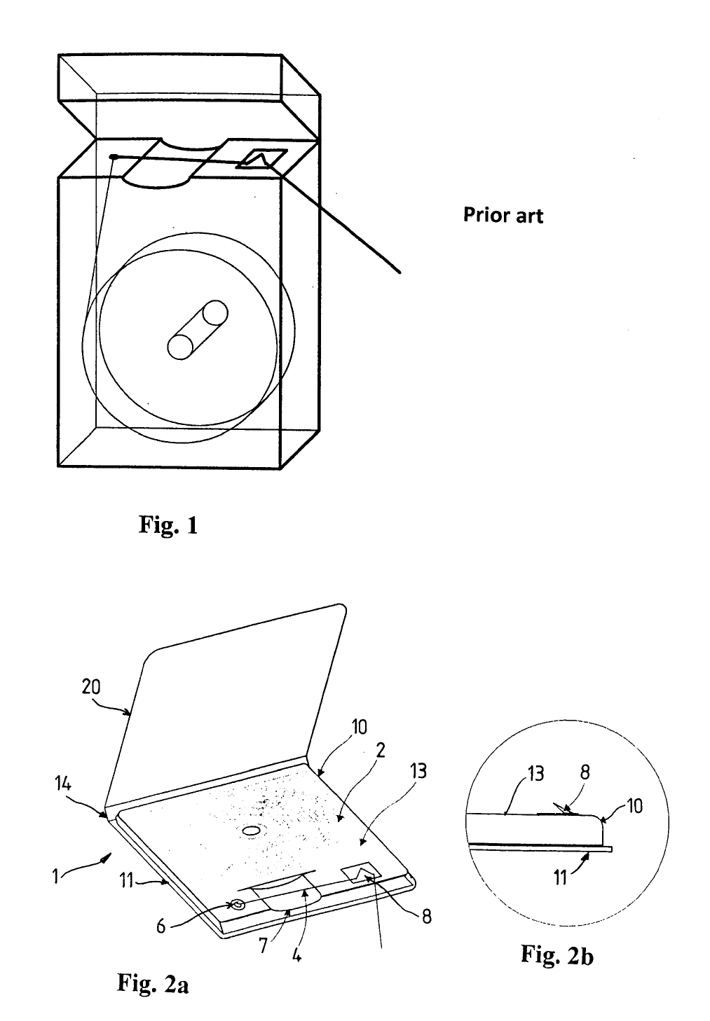

typical embodiment is shown in FIG. 1 and its closer description is given in a later part of the present specification.

Such devices are similar in size design to match boxes that are stored in pockets or women store them in their handbags. For using such devises a cap closing the top of the box has to be opened, and a filament section that extends out of the box can be pulled out and cut by a cutter to obtain the dental floss section ready for cleaning the teeth.

A drawback of such designs is the high volume compared to the task fulfilled, and the fact according to which for pulling out and cutting the filament the box should b held by two hands and not by using two fingers when the box is positioned on a table, and before that operation the cap should be opened, and the other hand is used for pulling and cutting.

Such devices have a further characteristic, namely they are bound to the person of the user, and therefore anyone who wishes to use a dental floss has to keep one such device with him/her. Several other embodiments of the dental floss holding and feeding devices are know, e.g. in case of the document EP 666224A1 the filament leaves the rectangular box at one of its narrow sides, and close to it the cutter extends out in lateral direction. In this embodiment the end of the filament extends of from the box till its next use, it can get contaminated and there is the danger that this filament end slips back in the interior space that renders any subsequent use impossible. It is difficult to grip the end of the filament, and during this operation the proximity of the cutter is dangerous, furthermore the cutter which is open in lateral direction might cause accidents.

The document U.S. Pat. No. 5,076,423 shows several embodiments, but in all of them the cutter is located outside , therefore when the device is caught the cutter might also be touched that might cause injuries. The end of the filament that remains after the cutting is not protected from being contaminated that renders its use less hygienic.

The document U.S. Pat. No. 5,076,423 shows different ways of guiding the filament in the interior space, the cutter is not covered from the outside and the cut end of the filament also ex-tends in the free outer space, therefore this solution is likewise not hygienic.

The object of the invention is to improve dental floss devices that constitute part of modern oral hygiene by decreasing their unnecessarily high volume, simplifies their way of use, and which is free from the drawbacks of known devices i.e. it protects the fingers from being accidentally touched, keeps the cut end of the filament in a closed protected space and enables easy handling by having an appropriately designed manipulation field. A further object of the invention is to provide a sufficiently large field for the placement of promotions.

For solving these objectives it has been discovered that unlike to the conventional design of dental floss holding and feeding devices the flat closed inner space is defined mainly by a pair of spaced parallel sheets, and there is a need for a third sheet that can be folded on this flat space just as the cover of a book can be folded to take a closed position and the cover can protect and close that space, and after unfolding the cover plate the device will be ready for us, whereby the cover provides a large surface for the placement of promotions.

According to the invention a dental floss holding and feeding device has been provided which is designed and characterized as defined by the attached claims.

The device according to the invention will now be described in connection with preferable embodiments thereof, in which reference will be made to the accompanying drawings. In the drawing:

FIG. 1 shows the perspective view of a known dental floss holding and feeding device;

FIG. 2 shows an embodiment of the assembled dental floss holding and feeding device according to the invention in a ready to use position;

FIGS. 2a and 2b show respective enlarged details of FIG. 2;

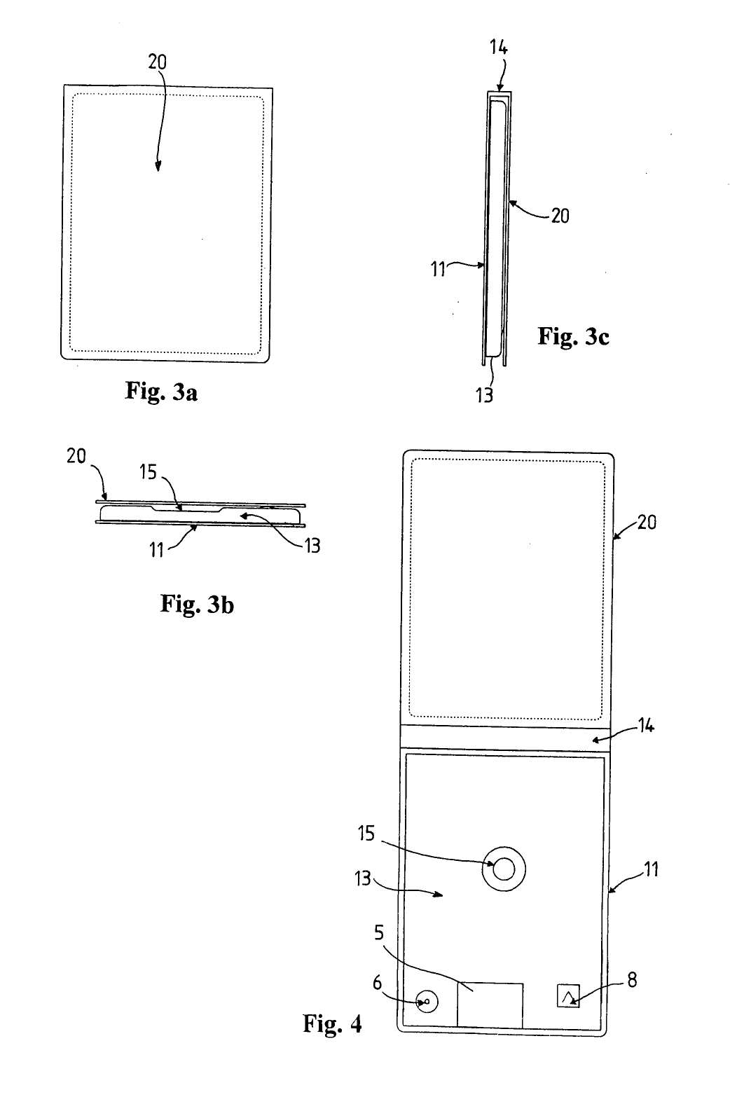

FIGS. 3a, 3b and 3c show the elevation, bottom and top views of the dental floss holder when the front cover is folded on the base plate;

FIG. 4 shows the dental floss holding and feeding device when the front cover is in unfolded open position; and

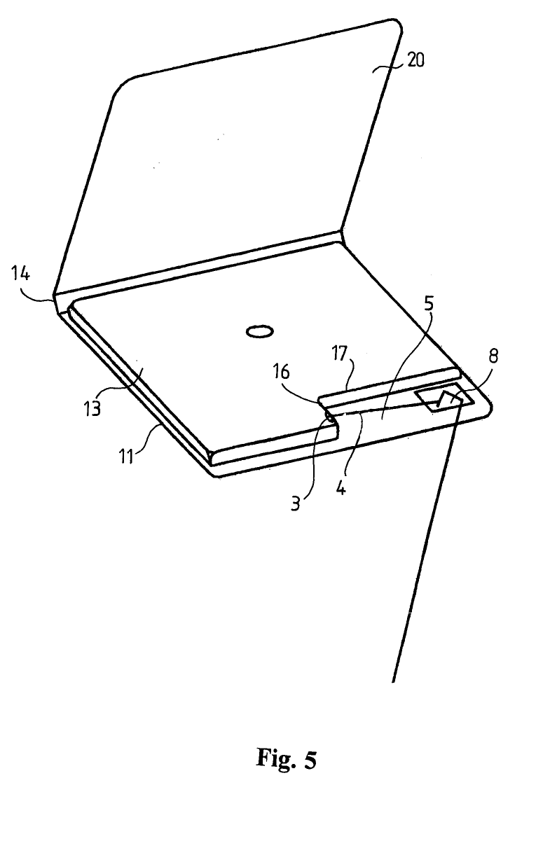

FIG. 5 shows a further embodiment of the device according to the invention.

FIG. 1 shows a known dental floss holding and feeding device that has a narrow, high box-like body that stands on the narrow side, and a cover is arranged at the top of the box which can be opened and closed. In the interior of the body a shaft is provided (which is horizontal when the box is in the shown standing position) around which a winding of dental floss is arranged with a winding plane normal to the shaft. On the narrow upper side of the box a bore is provided through which the dental floss can be lead out in tangential direction from the interior of the box. A cutter means is arranged on the upper side of the box spaced from the bore. In the section between the cutter and the bore a recess or a depression is provided on the top of the box that allows easier holding of the dental floss.

The cover is usually in closed position, and the dental floss holding and feeding device is normally kept like a matchbox in the pocket or handbag of the owner.

When the device is used, the cover is folded out and the box is held in one hand, and with the other hand the dental floss extending out of the bore is pulled until it reaches the required length during which step the floss is unwound from the winding. Then the inward end part of the floss is inserted in the cutter and the required section can be cut upon a slight pulling movement.

This operation requires both hands because one hand is used to hold the box. It is worthwhile to realize that in this prior art device the plane of the upper side of the box that forms the top and holds the cutter is parallel with the shaft and this side is the narrow side of the flat box.

Such a design is characterized by a comparatively high volume, the winding has a substantial thickness compared to its diameter, and the surface that can be used for handling falls on the narrow top of the flat box.

In contrast to such design the dental floss holding and feeding device 1 according to the present invention and shown in FIGS. 2a and 2b has a flat, preferably rectangular body 10 onto which a cover 20 can be folded as if was a small booklet or a notebook. The cover 20 and base plate 11 of the body 10 can be made preferably by a cardboard or hard but foldable sheet material like the material of flat match boxes that are used not only for providing matches but also to contain advertisement or visual information on their comparatively large and flat surfaces. In the design according to the invention for placing advertisements both faces of the cover 20 can be used (of which the inner face will be visible when the cover 20 is folded out) just as the bottom face of the base plate 11. If needed, inscriptions can also be placed on the narrow rectangular rear edge 14 that interconnects the base plate 11 and the cover 20. The cover 20, as will be explained later is not used only for placing advertisements thereon.

The cover 20 can be folded on the base plate 11 (see FIGS. 3b and 3c) so that it will be parallel with the base plate 11. The narrow flat space between these plates is fully or predominantly closed, and this inner space is determined at the bottom by the base plate 11 and by an envelope 13 at all sides and the top. The case 13 is made preferably by a transparent plastic thin sheet material or membrane like the blisters used for packing tablets for drugs. A flat winding 2 with a large diameter is arranged in this closed space which is wound in a self-supporting way from filaments 4 constituting the dental floss, and its shape is similar to that of a mill-wheel. The winding 2 has a central opening that has an axis normal to the plane of the base plate 11, and it is preferred if on the inner face of the base plate 11 a shaft 15 is fixed that has an axis also normal to the plane of the base plate 11. The shaft 15 can be fixed by an adhesive or by flanging. The shaft 15 is loosely fitted in the central opening of the winding 2 to allow turning of the winding 2 thereon when the filament 4 is fed when being pulled, but during the step-wise unwinding the winding 2 retains its stable shape.

At the left side of FIG. 2 a shaft 6 and/or an opening 3 is provided that have a task of guiding the filament 4 after having left the winding 2 and to lead it out from the inner space defined by the envelope 13. On the base plate 11 in front of the winding 2 a manipulation field 5 is provided by the appropriate shaping of the envelope 13 that has the task of assisting the user to grasp the remaining end of the filament 4 after it has passed through the opening 3 and a required section has been previously cut from it f or use. The width and depth of the manipulation field 5 can be increased or decreased by increasing or decreasing the width of the base plate 11.

In FIGS. 3a, 3b and 3c the folded shape of the dental floss holding and feeding device 1 can be seen in three different views. It can also be observed in these figures that in the narrow space between the base plate 11 and the cover 20 the envelope 13 covers and holds the winding 2 and also the major part of the inner space to prevent the disengagement of the winding 2 from the shaft 15 that acts as a pivot axis for the winding 2. In FIGS. 2 and 3b it can also be seen that the manipulation field 5 is constituted by a recess 7 or cut in the central part of the frontal region of the envelope 13 that provides room for the fingers to hold the end of the filament 4 that extends out of the opening 3 prior to any subsequent use. In the embodiment shown the guiding shaft 6 is arranged in the inner space of the envelope 13, and the filament 4 leaves the winding 2 in tangential direction i.e. parallel to the narrow side of the device and its path takes a 90° turn around the shaft 6 and proceeds in parallel to the longer front side towards the other side. As described, the filament 4 leaves the inner space defined by the envelope 13 through the opening 3 located above the upper plane of the base plate 11. in order to prevent the end of the filament 4 to be drawn back into the closed inner space under the envelope 13 the opening 3 can be designed to provide a certain friction with the filament 4 but narrow plastic members can also be arranged behind the opening 3 which allow only the forward (pulling) movement of the filament 4 and prevent movement in the other direction. The shaft 6 can also be omitted, and its role can be taken by the opening 3. The filament 4 is lead above the recess 7 and proceeds to cutter 8 arranged in the front part of the other side of the device. The cutter 8 is designed similarly to those used in the prior art devices and has a cutting part inclined slightly in V shape in upward direction, wherein one side of the V shape is sharpened to form an edge and can cut the filament 4 when pressed to it.

The positioning and a preferred embodiment of the cutter 8 is shown in the enlarged view of FIG. 2b. It is important to note that the cutter 8 is always arranged at the opposite side of the manipulation field 5 from the side where the opening 3 is arranged, therefore after the filament 4 has been cut by the cutter 8, a filament section will extend out of the opening 3 that is at least and about as long as the width of the manipulation field 5. When the cover 20 is folded on the envelope 13 it protects the user that his hand or fingers be accidentally hurt by the utter 8, furthermore it covers the manipulation field 5 and prevent the end of the filament 4 from any dirt or contamination, therefore it enables a more hygienic use.

FIG. 5 shows a further embodiment of the invention which differs primarily in the design of the envelope 13 from the previous embodiments In the frontal part he envelope 13 takes an L shaped jump, and past the opening 3 it has an edge 16 that extends substantially normal to the rear edge 14, then it changes direction and proceeds in parallel to the rear edge 14 along a front edge 17 and extends preferable till the side of the base plate 11. The manipulation field 5 is provided in front of these edges. In this embodiment the cutter 8 can be placed directly on the upper surface of the base plate 11 or through a narrow distance member spaced by a distance from the left edge 16 which is sufficiently high to allow manipulation. In other words the distance between the cutter and the inwardly directed edge 16 that prior to a new use the end of the filament 4 can be held by hand and pulled to the required length. Then the filament 4 is inserted in the V shaped part of the cutter 6 and being cut when a sudden puling force is used. The inwardly directed L-shaped jump of the envelope 13 has the same function as the recess 7 had in the previous embodiment and provides thereby the manipulation field 5. A further advantage of this embodiment lies in that the upper end of the cutter 8 is lower than the upper plane of the envelope 13 therefore its presence cannot affect the full folding of the cover on the envelope 13. The lower arrangement of the cutter 8 provides a further protection against accidental touching the sharp edge. The opening 3 that leads out the filament 4 from the inner space can also be arranged at the front edge of the envelope 13, but it is more preferred if the opening 3 is made at the inwardly directed edge 16 because inn that way the filament proceeds always in the protected manipulation field 5 to the cutter 8.

From the point of view of ease of use the most preferred design of the body 10 its flat rectangular shape as described. The term “rectangular” includes naturally if the corner regions are rounded, moreover this might also include the flat trapezoid or other designs of the body 10 that all allows reaching the preset objectives.

According to the invention the use of the dental floss holding and feeding device 1 is simple because by the folding out of the cover 20 it will be easy to access to the filament 4 that extends out from the closed inner space, and by pulling the filament 4 the required length can be unwound, then the filament 4 is inserted in the recess of the cutter 8, and by pulling the extending portion of the filament 4 it will be cut to have the required length and the removed floss can be used for dental cleaning. Following the cutting step an end section of the filament 4 will extend out from the opening 3 that is at least as long as the width of the manipulation field 5. This makes it possible that during next use this extending filament section can be held y the fingers, pulled and the required length be cut. The design is preferred because also from the point of view that the manipulation field 5 is covered by the folded cover 20 and it will be protected from contamination. This advantage is obtained beside the other one, namely that the upwardly projecting cutter 8 is also covered by the cover 20. As described, the device according to the invention is ready for repeated hygienic uses after each use.

The flat design of the device according to the invention that has a small volume facilitates its use in restaurants and can eliminate the use of other toothpicks, and at the same time it is a practical and convenient carrier of advertisements on which the address and data and other information of the restaurant can be printed on the available large surfaces. Because in most of the countries smoking is not permitted in public spaces, the use of the device according to the invention can replace the role of the previously used flat matches as information carriers. This promotional function is realized in combination with an important hygienic function, namely the cleaning of the teeth after the meals.

The device not only differs from conventional dental floss boxes because it is an excellent promotional medium but the device can be laid on its large rectangular flat surface on the table without the danger of turning down, it has a smaller volume. The dental floss filament 4 that extends out from the inner space and the cutter 8 both fall in the covered plane of the base plate 11 or in a plane parallel with it, that extends normal to the shaft 15 constituting the pivot axis of the winding 2 and which is not parallel with this shaft as it is the case in most of the prior devices.

The preferred flat design that facilitates use can be opened by one hand and can be conveniently used because the arrangement of the opening 3, the manipulation field 5 and the cutter 8 render such use possible and simultaneously decreases the danger of accidents, furthermore it is more hygienic than most of the devices used up to the present.

The actual design of the device according to the invention can be realized in several forms that differ from the exemplary embodiments show, i.e. instead of the blister any no-transparent envelop 13 can be used, the proportions of the actual design can be changed, furthermore the positioning and realization of the cutter 8 can take several versions. The material of the device can be cardboard, plastic and even a flexible metallic sheet material. These variations can be freely chosen within the scope and spirit of the attached claims.

1. Dental floss holding and feeding device comprising a body (10); a winding (2) made of dental floss filament (13) and that has a winding plane, the winding (2) comprises a central opening normal to the plane of the winding (2); a shaft (15) with an axis normal to the plane of the winding (2), the shaft (15) is fitted in the opening of the winding (5) that allows turning of the winding around the shaft (15); a base plate (11) supporting a side of the winding (2) and at least one closed space in the body (10) for locating the winding (2), an opening (3) in the wall of said closed space for leading out a filament (4) constituting an end portion of the winding (2); and a cutter (8) arranged across the path of the lead out filament (4) to cut the filament when being suddenly pulled, characterized in that the winding (2) has a flat, narrow shape compared to the size of its own diameter, the body (10) has a larger plane constituted by said base plate (11); the body (10) has a narrow rear edge (14) to which a cover (20) is attached that can be folded in a position parallel to the base plate (11) and opened by unfolding; an envelope (13) is attached to the base plate (11) and defining said closed inner space that includes at least said winding (2), said envelope (13) has an upper surface that is substantially parallel to the base plate (11), the height of the envelope (13) is substantially equal to the width of said rear edge (14), and the cover (20) in folded position covers the upper surface of the envelope (13), and behind the front edge of the base plate (11) a manipulation field (5) is provided that extends between said lead out opening (3) and said cutter (8), the manipulation field (5) enables holding the previously cut end of the filament (4) by hand, said manipulation field (5) is defined by the shape of said envelope (13), and the cutter (8) is fixed directly or through an insert member to the base plate (11).

2. The dental floss holding and feeding device as claimed in claim 1, characterized in that in the space closed by the envelope (13) behind the lead out opening (3) a filament guiding shaft (6) is arranged that changes the direction of passage of the filament (4).

3. The dental floss holding and feeding device as claimed in claim 1, characterized in that the manipulation field (5) is constituted by a recess (7) of the envelope (13) made in a portion between the lead out opening (3) and the cutter (8).

4. The dental floss holding and feeding device as claimed in claim 1, characterized in that at least one of the faces of the cover (20) and preferably also the surface of the rear edge (14) comprises promotional information.

5. The dental floss holding and feeding device as claimed in claim 1, characterized in that the frontal edge portion of the envelope (13) comprises a substantially L-shaped edge section behind the manipulation field (5).

6. The dental floss holding and feeding device as claimed in claim 1, characterized in that the cover (20) has a size and shape substantially equal to the size and shape of the base plate (11) and covers the space defined between them when being folded.

7. The dental floss holding and feeding device as in claim 1, characterized in that the body (10) has a rectangular shape and the lead out opening (3), the manipulation field (5) and the cutter (8) are arranged along the wider side of the rectangle.
